(19) United States
(12) Patent Application Publication
(10) Pub. No.: US 2026/0031249 A1
(43) Pub. Date: Jan. 29, 2026

(54) ATOM TRAP DEVICES AND METHODS FOR MANUFACTURING THEREOF

(71) Applicant: Infineon Technologies Austria AG, Villach (AT)

(72) Inventors: Nina Agnieszka Megier, Villach (AT); Yves Colombe, Villach (AT); Clemens Rössler, Villach (AT); Fabian Laurent, Villach (AT); Silke Katharina Auchter, Villach (AT)

(21) Appl. No.: 19/269,176

(22) Filed: Jul. 15, 2025

(30) Foreign Application Priority Data
Jul. 26, 2024 (DE) 102024121364.7

(51) Int. Cl. G21K 1/00

(52) U.S. Cl. CPC G21K 1/00

(57) ABSTRACT

An atom trap device includes a substrate, a structured metal layer arranged above the substrate and configured to generate at least one of a magnetic, electric or electromagnetic field for controlling atoms in a zone above the structured metal layer, and a crystalline or polycrystalline dielectric material arranged between the substrate and the structured metal layer. The crystalline or polycrystalline dielectric material includes at least one planar layer extending substantially parallel to the structured metal layer. The crystalline or polycrystalline dielectric material is in contact with the structured metal layer.

### TECHNICAL FIELD

The present disclosure relates to atom trap devices and methods for manufacturing atom trap devices.

### BACKGROUND

During an operation of atom trap devices heat may be generated by e.g. RF lines or microwave structures. Accumulation of heat in an atom trap device may have a negative impact on the operation of the atom trap devices. For example, the vacuum quality may be impaired or undesired surface noise may occur. In view of the above, it may be desirable to provide solutions minimizing the heating of atom trap devices.

### SUMMARY

An aspect of the present disclosure relates to an atom trap device. The atom trap device comprises a substrate, a structured metal layer arranged above the substrate, wherein the structured metal layer is configured to generate at least one of a magnetic, electric or electromagnetic field for controlling atoms in a zone above the structured metal layer, and a dielectric material arranged between the substrate and the structured metal layer, wherein the dielectric material is crystalline or polycrystalline. The crystalline or polycrystalline dielectric material comprises at least one planar layer extending substantially parallel to the structured metal layer. The crystalline or polycrystalline dielectric material is in contact with the structured metal layer.

A further aspect of the present disclosure relates to a method for manufacturing an atom trap device. The method comprises providing a substrate, forming a dielectric material above the substrate, wherein the dielectric material is crystalline or polycrystalline, and forming a structured metal layer above the crystalline or polycrystalline dielectric material, wherein the structured metal layer is configured to generate at least one of a magnetic, electric or electromagnetic field for controlling atoms in a zone above the structured metal layer. The crystalline or polycrystalline dielectric material comprises at least one planar layer extending substantially parallel to the structured metal layer. The crystalline or polycrystalline dielectric material is in contact with the structured metal layer.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 schematically illustrates a side view of an atom trap device in accordance with the disclosure.

FIG. 2 schematically illustrates a side view of an atom trap device in accordance with the disclosure.

FIG. 3 schematically illustrates a side view of an atom trap device in accordance with the disclosure.

FIGS. 4A to 4C schematically illustrate different views of an atom trap device in accordance with the disclosure.

FIG. 5 schematically illustrates a side view of an atom trap device in accordance with the disclosure.

FIGS. 6A and 6B schematically illustrate different views of an atom trap device in accordance with the disclosure.

FIG. 7 schematically illustrates a side view of an atom trap device in accordance with the disclosure.

FIGS. 8A to 8C schematically illustrate different views of an atom trap device in accordance with the disclosure.

FIG. 9 schematically illustrates a side view of an atom trap device in accordance with the disclosure.

FIG. 10 schematically illustrates a side view of an atom trap device in accordance with the disclosure.

FIG. 11 schematically illustrates a side view of an atom trap device in accordance with the disclosure.

FIG. 12 schematically illustrates a side view of an atom trap device in accordance with the disclosure.

FIG. 13 schematically illustrates a side view of an atom trap device in accordance with the disclosure.

FIG. 14 schematically illustrates a side view of an atom trap device in accordance with the disclosure.

FIG. 15 schematically illustrates a side view of an atom trap device in accordance with the disclosure.

FIG. 16 illustrates a flowchart of a method for manufacturing an atom trap device in accordance with the disclosure.

### DETAILED DESCRIPTION

The following description relates to devices for controlling trapped atoms (atom trap devices) and methods for manufacturing atom trap devices. In particular, the atom trap devices described herein may correspond to ion trap devices which may be configured to trap ions (charged atoms or molecules) and control the trapped ions. Atom trap devices may be implemented as atom trap chips in form of small, micro-fabricated devices configured to trap and manipulate individual atoms in a controlled manner. It is to be noted that the following description is not restricted to atoms, but may also be applied to ions, molecules or other quantum particles/systems (e.g. electrons or defect centers).

In some examples, atom trap devices as described herein may be used for quantum computing, but are not restricted thereto. Trapped atoms (more particular trapped ions) are one of the most promising candidates for being used as qubits in quantum computers, since they can be trapped with rather long lifetimes by means of electromagnetic fields. In this context, each atom may represent a physical qubit. However, atom trap devices in accordance with the disclosure are not restricted to the application of quantum computing. The atom trap devices presented herein may also be used for other applications, such as e.g. atomic clocks.

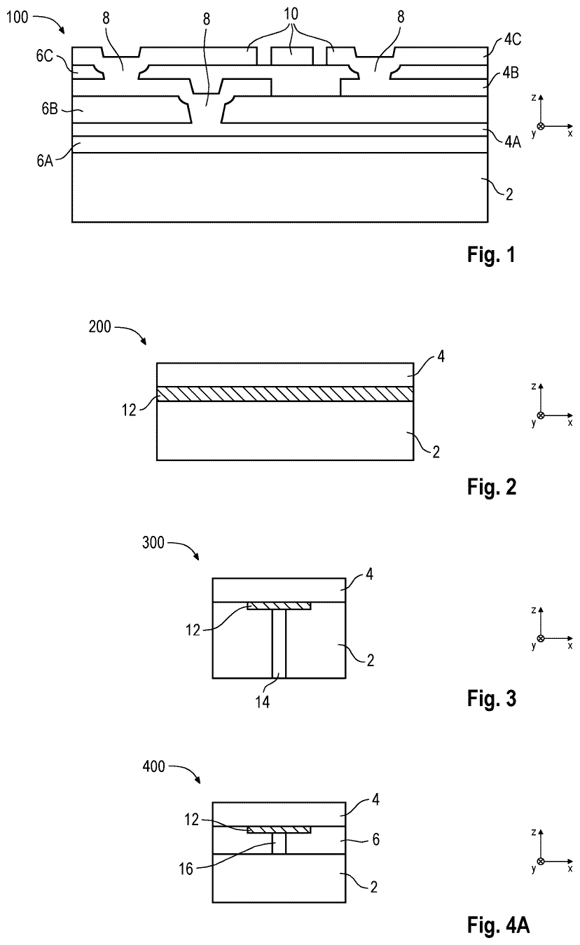

Referring now to FIG. 1, an atom trap device 100 in accordance with the disclosure is shown. For the sake of simplicity, FIG. 1 may only show a portion or detail of the atom trap device 100. The atom trap device 100 may include a substrate 2, a plurality of metal layers 4A to 4C arranged above the substrate 2, a plurality of dielectric layers 6A to 6C arranged above the substrate 2 and a plurality of metal vias 8 electrically connecting the metal layers 4A to 4C. In the illustrated example, exemplary numbers of three metal layers and three dielectric layers are shown. It is to be understood that in further examples, the number of respective layers may differ and may depend on the specific design of the atom trap device 100.

The metal layers 4A to 4C and the dielectric layers 6A to 6C may extend substantially parallel to the top surface of the substrate 2, i.e. in the x-y-plane. The dielectric layers 6A to 6C may be configured to electrically isolate the metal layers 4A to 4C from each other. The metal vias 8 may extend through the dielectric layers 6A to 6C in a substantially vertical direction, i.e. in the z-direction. The metal vias 8 may be configured to electrically connect metal layers arranged on different levels with respect to the z-direction. The metal layers 4A to 4C may include or may be made of a metal, coated metal or a metal alloy, such as e.g. at least one of aluminum, copper, gold or alloys thereof. The metal vias 8 may include or may be made of a similar material. The dielectric layers 6A to 6C may include or may be made of an (in particular amorphous) dielectric material, for example at least one of an (in particular amorphous) oxide or nitride, in particular amorphous silicon dioxide. The substrate 2 may include or may be made of at least one of silicon, silicon carbide, fused silica, sapphire, glass, aluminum nitride, diamond.

The uppermost metal layer 4C may include or may correspond to a structured electrode layer forming multiple electrodes 10 of the atom trap device 100. In the illustrated example, the electrodes 10 may consist of a single metal layer. In further examples, at least one of the electrodes 10 may be formed by a stack of conductive layers, such as e.g. Al/Ti/Pt/Au. The structured metal layer 4C (or the electrodes 10) may be configured to trap atoms in a zone above the structured electrode layer 4C. Atoms trapped in or by the atom trap device 100 may be shuttled (or transported) along shuttling paths of the device. For example, the shuttling paths may extend above the structured electrode layer 4C including the electrodes 10. In particular, a shuttling path may be arranged in a plane over (and in particular parallel to) the structured electrode layer 4C. Time-dependent electric fields may be used for shuttling atoms along the shuttling paths. A shuttling of atoms may be controlled by electric voltages applied to the electrodes 10 of the structured electrode layer 4C. In this context, the atom trap device 100 may further include at least one unit (not illustrated) configured to control the electric voltages applied to the electrodes 10, such as e.g. a control chip.

In some examples, the trapped atoms can be moved along shuttling paths by means of AC and DC voltages that may be separately coupled to specific electrodes 10 of the structured electrode layer 4C. For example, the structured electrode layer 4C may include RF electrodes for RF trapping and DC electrodes for static electric-field trapping and/or for moving the atoms (or more particular ions) within the atom trap device. As another example, atoms may be confined by the combination of an external magnetic field and electrostatic quadrupole fields generated by voltages applied to DC electrodes. Atom trap devices as described herein may be configured to trap a plurality of atoms that may be individually addressable and movable by appropriately controlling the electric potentials of the electrodes 10.

In one specific but non-limiting example, atom trap devices as described herein may correspond to or may include a surface atom trap (or surface-electrode atom trap). In surface atom traps, all electrodes 10 (i.e. the DC electrodes and the RF electrodes) may be arranged in a same single plane. Atoms may be stored and shuttled above this single plane. However, it is to be understood that the concepts described herein are not restricted to surface atom traps. In further examples, devices for controlling trapped atoms in accordance with the disclosure may also be based on three-dimensional atom trap geometries (e.g., where two or more trapping planes are arranged on top of each other).

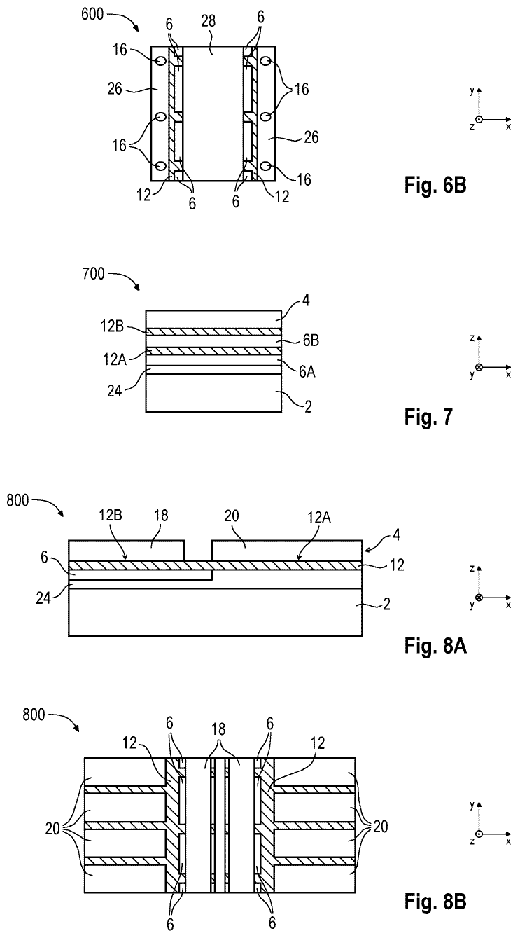

The uppermost metal layer 4C is not restricted to include electrodes 10 as previously described. Additionally, or alternatively, the metal layer 4C may include at least one microwave structure formed therein. Microwave structures of an atom trap device may be configured to support an application of microwave signals and/or microwave radiation to the trapped atoms. In particular, the microwave structures may be configured for a redistribution and delivery of microwave radiation to the trapping region where the atoms may be trapped. In a non-limiting example, a microwave structured may be implemented in form of a coplanar waveguide as e.g. described in connection with FIGS. 6A and 6B.

The metal layers 4A and 4B arranged between the substrate 2 and the top metal layer 4C may include or may correspond to e.g. an electrical redistribution layer. For example, such electrical redistribution layer may form at least a part of an electrical redistribution between the electrodes 10 and a control chip for controlling electric voltages applied to the electrodes 10. In the illustrated example, the electrical redistribution layer may exemplarily consist of two metal layers 4A and 4B. In further examples, the electrical redistribution layer may be implemented as a single metal layer or may include even more than two metal layers arranged on different levels with respect to the z-direction.

Referring now to FIG. 2, an atom trap device 200 in accordance with the disclosure (or a portion thereof) is shown. The atom trap device 200 may include some or all features of the atom trap device 100 of FIG. 1, wherein some features may be omitted for the sake of simplicity. The atom trap device 200 may include a substrate 2 and a structured metal layer 4 arranged above the substrate 2, wherein a detailed structuring of the metal layer 4 is not shown for the sake of simplicity. The structured metal layer 4 may be configured to generate at least one of a magnetic, electric or electromagnetic field for controlling atoms in a zone above the structured metal layer 4. The atom trap device 200 may further include a dielectric material 12 (see hatched area) arranged between the substrate 2 and the structured metal layer 4.

The dielectric material 12 may be crystalline or polycrystalline. In this regard, the crystalline or polycrystalline dielectric material 12 may differ from an amorphous dielectric material 6 as described in connection with FIG. 1. For example, the crystalline or polycrystalline dielectric material 12 may include or may be made of at least one of aluminum nitride, silicon nitride, aluminum oxide, beryllium oxide, beryllium nitride, silicon oxide. In case of a polycrystalline dielectric material 12, an average grain size of the polycrystalline dielectric material (such as an average diameter of grains formed by the dielectric material) may be significantly greater than an interatomic distance (which typically lies below 1 nm). For example, an average grain size of the polycrystalline dielectric material may be at least 4 nm or at least 10 nm or at least 15 nm or at least 20 nm or at least 30 nm. The crystalline or polycrystalline dielectric material 12 may provide a high thermal conductivity despite a low electrical conductivity. The dielectric material 12 may thus also be referred to as “highly thermal conducting dielectric”. In particular, the thermal conductivity of the crystalline or polycrystalline dielectric material 12 may be higher than the thermal conductivity of an amorphous dielectric material 6 as discussed in connection with FIG. 1. The physical origin of its high thermal conductivity may be due to a heat distribution provided by a vibration of the crystal lattice or crystalline structure of the dielectric material 12. In other words, the dielectric material 12 may be configured to provide a phononic heat transport.

Due to its high thermal conductivity, the crystalline or polycrystalline dielectric material 12 may at least partially form a heat bridge (or part of a heat bridge) between the structured metal layer 4 and the substrate 2. For this purpose, the crystalline or polycrystalline dielectric material 12 may be in contact with the structured metal layer 4. In general, the dielectric material 12 may be in thermal contact with the structured metal layer 4. That is, the contact between the two components may be configured to allow a flow of heat via the thermal contact. Additional elements, such as e.g. very thin layers, may be arranged between the dielectric material 12 and the structured metal layer 4 as long as their presence does not substantially change the heat flow. More particular, the dielectric material 12 may be in direct (or physical or direct physical) contact with the structured metal layer 4 so that the heat transfer is not reduced by intervening components. In a similar fashion, the crystalline or polycrystalline dielectric material 12 may be in thermal contact and/or in direct physical contact with the substrate 2.

In general, the crystalline or polycrystalline dielectric material 12 may include at least one planar layer extending substantially parallel to the structured metal layer 4, i.e. in the x-y-plane. In the non-limiting illustrated case, the dielectric material 12 may be implemented by a single planar layer substantially extending in the x-y-plane. In a first example, a dimension of the dielectric planar layer 12 when measured in the x-y-plane may be greater than or equal to a dimension of the dielectric planar layer 12 when measured in the z-direction. In a second example, a dimension of the dielectric planar layer 12 when measured in the x-y-plane may be smaller than or equal to a dimension of the dielectric planar layer 12 when measured in the z-direction. As previously discussed, the crystalline or polycrystalline dielectric material 12 may form a heat bridge between the structured metal layer 4 and the substrate 2 in the vertical direction. That is, the dielectric layer 12 may provide a heat transport in the vertical direction, in particular towards a cryostat (or cryostat head) which may be arranged below the substrate 2. Additionally, or alternatively, the dielectric material 12 may provide a heat transport in the lateral direction, i.e. in the x-y-plane (e.g., the heat bridge may comprise a part with a lateral direction in addition to a part with the vertical direction).

During an operation of the atom trap device 200 heat may be generated by one or multiple device components, such as RF electrodes, DC electrodes, microwave structures, dielectrics, integrated electronics, etc. Accumulation of high temperatures may have a negative impact on the operation and functionality of the atom trap device 200. Accordingly, when operating the atom trap device 200, an aim may be to minimize as far as possible the heating of the device due to power dissipation caused by the above-mentioned components. Minimizing the heating of device components may improve the quality of the vacuum and may lower surface noise, which in turn may reduce quantum gate errors. In addition, the integrity of the atom trap device 200 may be improved in that many heating and cooling cycles can exemplarily damage a bond interface between materials with different coefficient of thermal expansion (CTE) or too high temperature may even melt some materials. Furthermore, the properties of some materials may improve at lower temperatures. For example, metals may have smaller resistivity (e.g. RRR (Residual Resistance Ratio)>1). A heat bridge between the heat generating components and substrate 2 may allow the transport of heat and may ensure a lower temperature of the atom trap device 200 and may lower the dissipated power, which may be beneficial for cryogenic operation. It can additionally enable using smaller structures and can generally drive a miniaturization of atom trap devices.

A usage of the crystalline or polycrystalline dielectric material 12 having a high thermal conductivity may decrease the temperature of the atom trap device 200. In this regard, the crystalline or polycrystalline dielectric material 12 may be arranged under the entire top surface of the atom trap device 200 or only beneath structures generating heat, such as RF lines, micro-wave lines, current carrying wires, etc. It is to be understood that above comments regarding the effects of the high thermal conductivity and heat transport capability of the dielectric material 12 may also hold true for all other atom trap devices in accordance with the disclosure described herein.

In one example, the structured metal layer 4 may correspond to the metal layer 4C of FIG. 1 including electrodes 10. That is, the structured metal layer 4 may be configured to trap atoms in a trapping zone located above the structured electrode layer 4. In such case, the crystalline or polycrystalline dielectric material 12 may be arranged beneath at least one RF electrode included in the structured metal layer 4. In a further example, the crystalline or polycrystalline dielectric material 12 may be arranged beneath at least one microwave structure formed in the structured metal layer 4. Heat generated by the RF electrode and/or the microwave structure may be dissipated via the crystalline or polycrystalline dielectric material 12 (e.g. towards a cryostat head) in order to reduce a temperature of the atom trap device 200.

Referring now to FIG. 3, an atom trap device 300 in accordance with the disclosure (or a portion thereof) is shown. The atom trap device 300 may include some or all features of previously described atom trap devices. The atom trap device 300 may include at least one metal via 14 extending through the substrate 2 in a direction substantially perpendicular to the structured metal layer 4, i.e. in the z-direction. In the illustrated example, a single metal via 14 is shown for the sake of simplicity. In further examples, the number of metal vias 14 may differ and may be chosen according to a specific design of the atom trap device 300. The metal via 14 may be in (thermal and/or direct) contact with the crystalline or polycrystalline dielectric material 12. In particular, the metal via 14 may be configured to support a heat transport from the structured metal layer 4 via the dielectric material 12 in the vertical direction, for example towards a cryostat head located beneath the substrate 2.

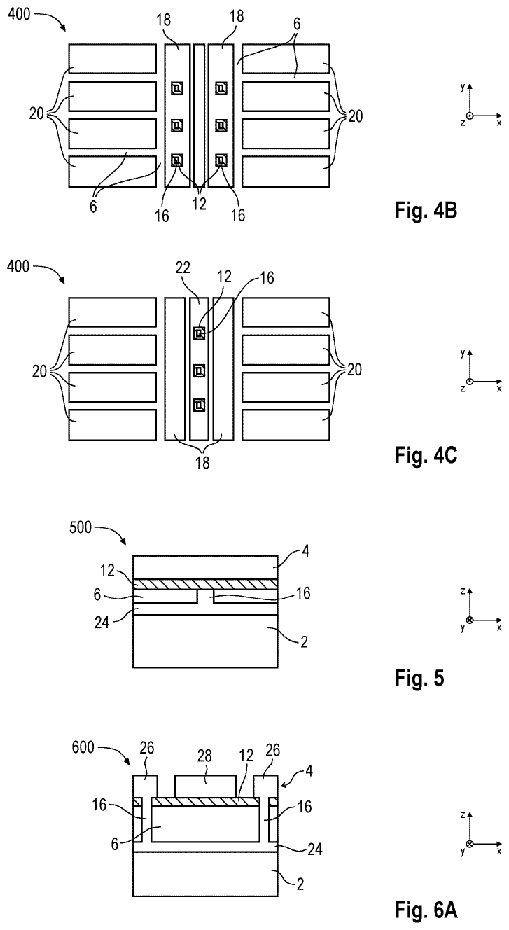

Referring now to FIGS. 4A to 4C, a side view and two top views of an atom trap device 400 in accordance with the disclosure (or a portion thereof) are shown. The atom trap device 400 may include some or all features of previously described atom trap devices. Besides the crystalline or polycrystalline dielectric material 12, the atom trap device 400 may further include an amorphous dielectric material 6 arranged between the substrate 2 and the structured metal layer 4. The amorphous dielectric material 6 may correspond to the dielectric material 6 previously discussed in connection with the example of FIG. 1. In one example, the dielectric material 6 may include or may be made of amorphous silicon dioxide. The crystalline or polycrystalline dielectric material 12 may be arranged between the amorphous dielectric material 6 and the structured metal layer 4. The atom trap device 400 may further include at least one metal via 16 extending through the amorphous dielectric material 6 in a direction substantially perpendicular to the structured metal layer 4, i.e. in the z-direction. In the illustrated example, a single metal via 16 is shown for the sake of simplicity. In further examples, the number of metal vias 16 may differ and may be chosen based on a specific design of the atom trap device 400. The metal via 16 may be in contact with the crystalline or polycrystalline dielectric material 12 and/or with the substrate 2 and may be configured to support a heat transport in the vertical direction.

In one example, the structured metal layer 4 may include at least one RF electrode 18 as e.g. shown in the exemplary top view of FIG. 4B. In the illustrated example, the atom trap device 400 may include two parallel RF electrodes 18 extending in the y-direction. In addition, the structured metal layer 4 may include a plurality of DC electrodes 20 that may be arranged to the left and to the right of the RF electrodes 18. Multiple portions of crystalline or polycrystalline dielectric material 12 as well as multiple metal vias 16 may be arranged along and beneath the RF electrodes 18. The dielectric material portions 12 and the metal vias 16 may form thermally conductive pillars configured to provide a heat transport in the z-direction as shown in FIG. 4A. In the illustrated top view, the portions of dielectric material 12 may have the exemplary shape of squares. In further examples, the shape of the dielectric material portions 12 may be chosen differently, for example, rectangular, circular, elliptical, etc. Note that in practice the crystalline or polycrystalline dielectric material 12 and the metal vias 16 may be covered by the material of the RF electrodes 18 and may thus not be visible in the illustrated top view.

Additionally, or alternatively, the structured metal layer 4 may include at least one microwave structure 22 as e.g. shown in the exemplary top view of FIG. 4C. In the illustrated example, the atom trap device 400 may include a single microwave structure 22 extending in the y-direction. Multiple portions of crystalline or polycrystalline dielectric material 12 as well as multiple metal vias 16 may be arranged along and beneath the microwave structure 22. Again, the dielectric material portions 12 and the metal vias 16 may form thermally conductive pillars configured to provide a heat transport in the z-direction.

Referring now to FIG. 5, an atom trap device 500 in accordance with the disclosure (or a portion thereof) is shown. The atom trap device 500 may include some or all features of previously described atom trap devices. In particular, the atom trap device 500 may be at least partially similar to the atom trap device 400 of FIGS. 4A to 4C. The atom trap device 500 may include a further metal layer 24 arranged between the substrate 2 and the crystalline or polycrystalline dielectric material 12. The further metal layer 24 may be in thermal and/or direct contact with the substrate 2. The further metal layer 24 may be arranged above the substrate 12 and may be embedded in the amorphous dielectric material 6. The at least one metal via 16 may be in contact with the further metal layer 24. In one example, the structured metal layer 4 may include a microwave structure as previously described in connection with the example of FIG. 4C.

Referring now to FIGS. 6A and 6B, a side view and a top view of an atom trap device 600 in accordance with the disclosure (or a portion thereof) are shown. The atom trap device 600 may include some or all features of previously described atom trap devices. In particular, the atom trap device 600 may be regarded as a more detailed version of the atom trap device 500 of FIG. 5. In the illustrated example, the structured metal layer 4 may include a coplanar waveguide having two ground planes 26 and a signal line 28 arranged in between. As can be seen from the exemplary top view of FIG. 6B, multiple metal vias 16 and the crystalline or polycrystalline dielectric material 12 may be arranged along and beneath the ground planes 26. In practice, the material of the ground planes 26 may cover the metal vias 16 which may therefore be obscured in the top view. The metal layer 24 arranged on the substrate 2 may include or may correspond to a ground layer, wherein the metal vias 16 extending through the amorphous dielectric material 6 may provide an electrical connection between this ground layer 24 and the ground planes 26 of the coplanar waveguide formed in the structured metal layer 4.

Referring now to FIG. 7, an atom trap device 700 in accordance with the disclosure (or a portion thereof) is shown. The atom trap device 700 may include some or all features of previously described atom trap devices. The amorphous dielectric material 6 and the crystalline or polycrystalline dielectric material 12 of the atom trap device 700 may form a layer stack including alternating layers of the amorphous dielectric material 6 and the crystalline or polycrystalline dielectric material 12. In the illustrated example, the atom trap device 700 may include exemplary numbers of two amorphous dielectric layers 6A, 6B and two crystalline or polycrystalline dielectric layers 12A, 12B. In further examples, the number layers may differ depending on a specific design of the atom trap device 700.

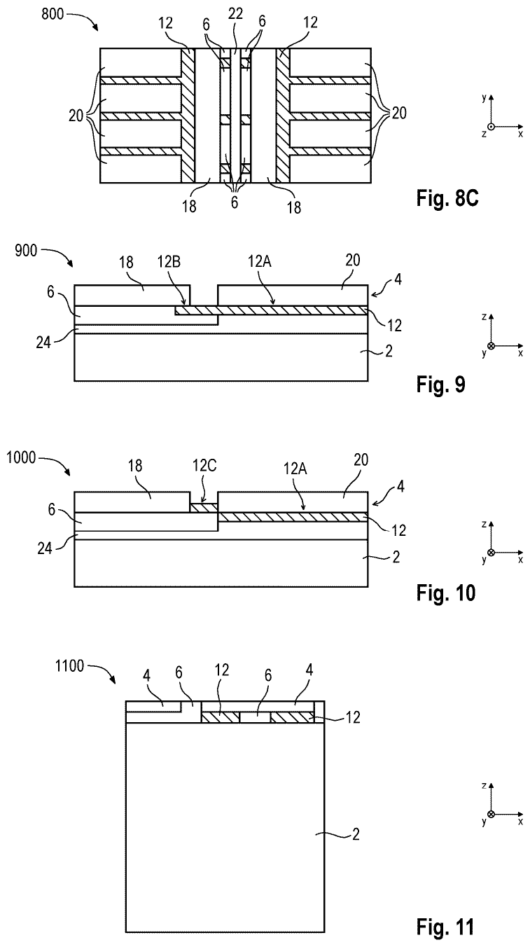

Referring now to FIGS. 8A to 8C, a side view and two top views of an atom trap device 800 in accordance with the disclosure (or a portion thereof) are shown. The atom trap device 800 may include some or all features of previously described atom trap devices. The structured metal layer 4 of FIGS. 8A to 8C may include at least one RF electrode 18 and a plurality of DC electrodes 20 arranged along the at least one RF electrode 18. In the illustrated example, the arrangement of the RF electrodes 18 and the DC electrodes 20 may be similar to the example of FIGS. 4A to 4C to which reference is made herewith. As can be seen from the side view of FIG. 8A, the crystalline or polycrystalline dielectric material 12 may form at least one strip or layer extending in the x-y-plane which may be configured to support a heat transport in the lateral direction. The crystalline or polycrystalline dielectric material 12 may include a first portion 12A arranged beneath the DC electrodes 20. The first portion 12A of the dielectric material 12 may be arranged between the structured metal layer 4 and a further metal layer 24 arranged above the substrate 2. In addition, the crystalline or polycrystalline dielectric material 12 may include a second portion 12B at least partially arranged beneath the at least one RF electrode 18. The second portion 12B of the dielectric material 12 may be arranged between the structured metal layer 4 and the amorphous dielectric material 6.

Referring now to FIG. 9, an atom trap device 900 in accordance with the disclosure (or a portion thereof) is shown. The atom trap device 900 may include some or all features of previously described atom trap devices. Compared to the example of FIGS. 8A to 8C, the size of the second portion 12B of the crystalline or polycrystalline dielectric material 12 may be reduced. In particular, the second portion 12B of the dielectric material 12 may only partially overlap the at least one RF electrode 18 when viewed in the z-direction. The reduced size of the second portion 12B may decrease an electrical capacity of the arrangement.

Referring now to FIG. 10, an atom trap device 1000 in accordance with the disclosure (or a portion thereof) is shown. The atom trap device 1000 may include some or all features of previously described atom trap devices. Compared to the examples of FIGS. 8A-8C and 9, the atom trap device 1000 may not necessarily include the second portion 12B of the crystalline or polycrystalline dielectric material 12 arranged beneath the RF electrodes 18. In the illustrated example, the crystalline or polycrystalline dielectric material 12 may include a third portion 12C arranged above the amorphous dielectric material 6. In particular, the second portion 12C may be arranged between the at least one RF electrode 18 and the DC electrodes 20.

In previous examples, the crystalline or polycrystalline dielectric material 12 has been described primarily as supporting a dissipation of heat generated by RF electrodes, DC electrodes and microwave structures. However, it is to be understood that atom trap devices in accordance with the disclosure may also include other heat generating structures. For example, a structured metal layer of an atom trap device may be configured to generate a magnetic field gradient in the trapping zone above the structured electrode layer. In some examples, such magnetic field gradient may be required for performing quantum gate operations on atoms trapped in the trapping zone. The trapped atoms may be used as qubits for performing quantum information processing, such as e.g. implementing quantum gates. In order to carry out quantum information processing with trapped atoms, the qubits formed by the atoms may be controlled using electromagnetic radiation. In one example, the performed quantum gate operations may be microwave-based. A necessary component of such microwave approach may be a magnetic field gradient provided in the zone of the trapped atoms. In practice, a magnetic field gradient may be applied to a cooled (in particular linear) chain of trapped atoms, wherein the atoms of the atom chain may serve as qubits distinguishable in frequency space such that they can be individually addressed. The magnetic field gradient may induce a pair wise spin-spin coupling between the individual qubits.

Referring back to the example of FIG. 1, a plurality of wires may be embedded in the dielectric material 6, wherein the plurality of wires may be configured to generate a magnetic field gradient in the zone above the structured metal layer 4C when carrying electrical currents. Such wires may be referred to as current carrying wires. For example, the current carrying wires may be arranged beneath the metal layers configured to trap atoms in the trapping zone above the structured electrode layer. In the example of FIG. 1, the current carrying wires may e.g. be formed in the metal layer 4A or in an additional metal layer (not illustrated) arranged between the top surface of the substrate 2 and the metal layer 4A. In order to support a dissipation of heat generated by the current carrying wires, a crystalline or polycrystalline dielectric material 12 may be in (thermal and/or direct) contact with at least one wire of the plurality of wires. For example, one or more portions of the (in particular amorphous) dielectric material 6 may be replaced by corresponding portions of a crystalline or polycrystalline dielectric material 12.

Referring now to FIG. 11, an atom trap device 1100 in accordance with the disclosure (or a portion thereof) is shown. The atom trap device 1100 may include some or all features of previously described atom trap devices. In the illustrated example, the polycrystalline dielectric material 12 may provide a direct mechanical coupling between the substrate 2 and the structured metal layer 4. Stated differently, the polycrystalline dielectric material 12 may be in direct (or physical or direct physical) contact with the substrate 2 and the structured metal layer 4 so that a heat transfer between these components is not reduced by intervening components. In particular, the polycrystalline dielectric material 12 may be in direct contact with the top surface of the substrate 2 and the bottom surface of the uppermost structured metal layer 4. In examples, the entire bottom surface of the polycrystalline dielectric material 12 may be in direct contact with the substrate 2 and/or the entire top surface of the polycrystalline dielectric material 12 may be in direct contact with the structured metal layer 4. The individual portions of the polycrystalline dielectric material 12 may be separated by the amorphous dielectric material 6.

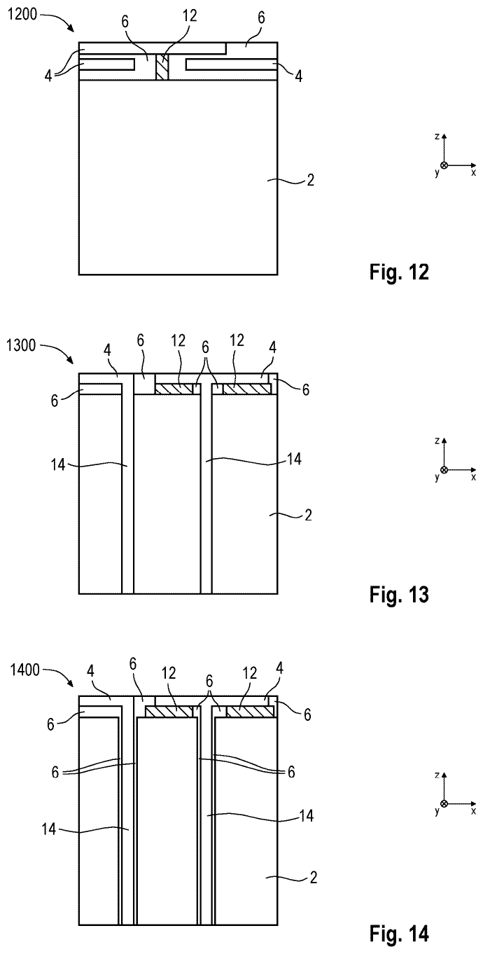

Referring now to FIG. 12, an atom trap device 1200 in accordance with the disclosure (or a portion thereof) is shown. The atom trap device 1200 may include some or all features of previously described atom trap devices. Similar to the example of FIG. 11, the polycrystalline dielectric material 12 may be in direct contact with the substrate 2 and the structured metal layer 4 so that a heat transfer between these components is not reduced by intervening components. In the illustrated example, the polycrystalline dielectric material 12 may be formed as one or more via-like dielectric connections extending between the substrate 2 and the structured metal layer 4.

Referring now to FIG. 13, an atom trap device 1300 in accordance with the disclosure (or a portion thereof) is shown. The atom trap device 1300 may include some or all features of previously described atom trap devices. In particular, the atom trap device 1300 may be at least partially similar to the atom trap device 1100 of FIG. 11. In the illustrated example, the atom trap device 1300 may include one or more metal vias 14 extending through the substrate 2 in a substantially vertical direction. In addition, the metal vias 14 may at least partially extend through the amorphous dielectric material 6. For example, the metal vias 14 may include or may correspond to through silicon vias (TSV) or through glass vias (TGV), depending on the material of the substrate 2. In the shown case, the metal vias 14 may extend from the uppermost structured metal layer 4 to the bottom surface of the substrate 2. That is, electrodes formed in the uppermost structured metal layer 4 may be electrically accessible from the bottom surface of the substrate 2. The metal via 14 on the right may at least partially extend between two portions of the polycrystalline dielectric material 12.

Referring now to FIG. 14, an atom trap device 1400 in accordance with the disclosure (or a portion thereof) is shown. The atom trap device 1400 may include some or all features of previously described atom trap devices. In particular, the atom trap device 1400 may be at least partially similar to the atom trap device 1300 of FIG. 13. Compared to the example of FIG. 13, a lateral dimension of the portions of the polycrystalline dielectric material 12 may be slightly enlarged. For example, the polycrystalline dielectric material 12 may at least partially protrude beyond the side surfaces of the portion of the structured metal layer 4 arranged above it. In the illustrated example, the amorphous dielectric material 6 may also be arranged between the metal vias 14 and the substrate 2. More particular, the amorphous dielectric material 6 may be arranged on the side walls of the via holes extending through the substrate 2 in a substantially vertical direction.

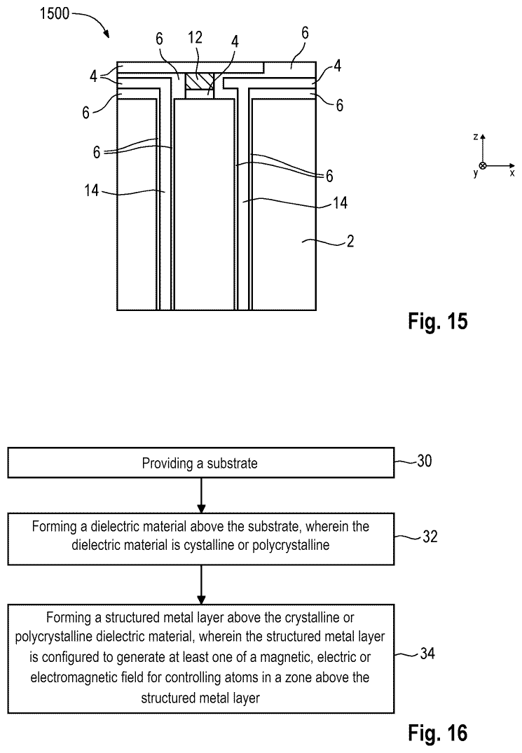

Referring now to FIG. 15, an atom trap device 1500 in accordance with the disclosure (or a portion thereof) is shown. The atom trap device 1500 may include some or all features of previously described atom trap devices. In the illustrated example, the polycrystalline dielectric material 12 may be in direct (or physical or direct physical) contact with metal layers of the structured metal layer 4 arranged on different levels, thereby providing a direct heat transfer between these different metal layers. In particular, the polycrystalline dielectric material 12 may be in direct contact with the uppermost metal layer 4 and in direct contact with a metal layer 4 that is in direct contact with the substrate 2. In such case, a heat transport between the substrate 2 and the uppermost metal layer 4 may be exclusively via the metal and the polycrystalline dielectric material 12.

Referring now to FIG. 16, a flowchart of a method for manufacturing an atom trap device in accordance with the disclosure is illustrated. The method is described in a general manner in order to qualitatively specify aspects of the disclosure. The method may be used for manufacturing any of the atom trap devices in accordance with the disclosure as described herein. Accordingly, the method may be read in connection with previously described atom trap devices. It is to be understood that the method may be extended by one or more additional aspects. For example, the method may be extended by any of the aspects described in connection with other example provided herein.

At 30, a substrate may be provided. At 32, a dielectric material may be formed above the substrate. The dielectric material may be crystalline or polycrystalline. At 34, a structured metal layer may be formed above the crystalline or polycrystalline dielectric material. The structured metal layer may be configured to generate at least one of a magnetic, electric or electromagnetic field for controlling atoms in a zone above the structured metal layer. The crystalline or polycrystalline dielectric material may include at least one planar layer extending substantially parallel to the structured metal layer. The crystalline or polycrystalline dielectric material may be in contact with the structured metal layer. In some examples, the step 32 can be omitted depending on the substrate material, and/or after the step 34 the repetitions of steps 32 and 34 can be implemented, to produce a multilayer atom trap. The dielectric layers may be structured in vertical and/or lateral directions (undercuts), and/or polished to obtain the structures which are described in the examples. Some metal layers may be used as electrical redistribution layers.

The examples described herein provide atom trap devices and methods for manufacturing atom trap devices.

Example 1 is an atom trap device, comprising: a substrate; a structured metal layer arranged above the substrate, wherein the structured metal layer is configured to generate at least one of a magnetic, electric or electromagnetic field for controlling atoms in a zone above the structured metal layer; and a dielectric material arranged between the substrate and the structured metal layer, wherein the dielectric material is crystalline or polycrystalline, wherein the crystalline or polycrystalline dielectric material comprises at least one planar layer extending substantially parallel to the structured metal layer, and wherein the crystalline or polycrystalline dielectric material is in contact with the structured metal layer.

Example 2 is an atom trap device according to Example 1, further comprising: a further metal layer arranged between the substrate and the crystalline or polycrystalline dielectric material, wherein the further metal layer is in contact with the substrate.

Example 3 is an atom trap device according to Example 1 or 2, wherein an average grain size of the polycrystalline dielectric material is at least 4 nm.

Example 4 is an atom trap device according to any of the preceding Examples, wherein the structured metal layer is configured to trap atoms in the zone above the structured electrode layer.

Example 5 is an atom trap device according to any of the preceding Examples, wherein the crystalline or polycrystalline dielectric material forms part of a heat bridge between the structured metal layer and the substrate.

Example 6 is an atom trap device according to any of the preceding Examples, wherein the crystalline or polycrystalline dielectric material is arranged beneath at least one RF electrode included in the structured metal layer.

Example 7 is an atom trap device according to any of the preceding Examples, wherein the crystalline or polycrystalline dielectric material is arranged beneath at least one microwave structure formed in the structured metal layer.

Example 8 is an atom trap device according to any of the preceding Examples, wherein the crystalline or polycrystalline dielectric material comprises at least one of aluminum nitride, silicon nitride, aluminum oxide, beryllium oxide, beryllium nitride.

Example 9 is an atom trap device according to any of the preceding Examples, wherein the crystalline or polycrystalline dielectric material is in contact with the substrate.

Example 10 is an atom trap device according to any of the preceding Examples, further comprising: at least one metal via extending through the substrate in a direction substantially perpendicular to the structured metal layer, wherein the at least one metal via is in contact with the crystalline or polycrystalline dielectric material.

Example 11 is an atom trap device according to any of the preceding Examples, further comprising: an amorphous dielectric material arranged between the substrate and the structured metal layer, wherein the crystalline or polycrystalline dielectric material is arranged between the amorphous dielectric material and the structured metal layer.

Example 12 is an atom trap device according to Example 11, wherein the amorphous dielectric material comprises silicon dioxide.

Example 13 is an atom trap device according to any of the preceding Examples, wherein the structured metal layer is configured to generate a magnetic field gradient in the zone above the structured electrode layer.

Example 14 is an atom trap device according to any of Examples 11 to 13, further comprising: a plurality of wires embedded in the amorphous dielectric material, wherein the plurality of wires is configured to generate a magnetic field gradient in the zone above the structured metal layer when carrying electrical currents, wherein the crystalline or polycrystalline dielectric material is in contact with at least one wire of the plurality of wires.

Example 15 is an atom trap device according to any of Examples 11 to 14, wherein the amorphous dielectric material and the crystalline or polycrystalline dielectric material form a layer stack comprising alternating layers of the amorphous dielectric material and the crystalline or polycrystalline dielectric material.

Example 16 is an atom trap device according to any of Examples 11 to 15, further comprising: at least one metal via extending through the amorphous dielectric material in a direction substantially perpendicular to the structured metal layer, wherein the at least one metal via is in contact with the crystalline or polycrystalline dielectric material.

Example 17 is an atom trap device according to Example 16, further comprising: a metal layer arranged above the substrate and embedded in the amorphous dielectric material, wherein the at least one metal via is in contact with the metal layer.

Example 18 is an atom trap device according to Example 17, wherein: the metal layer comprises a ground layer, and at least one metal via provides an electrical connection between the ground layer and a ground plane of a coplanar waveguide formed in the structured metal layer.

Example 19 is an atom trap device according to any of the preceding Examples, wherein: the structured metal layer comprises at least one RF electrode and a plurality of DC electrodes arranged along at least one RF electrode, and the crystalline or polycrystalline dielectric material comprises a first portion arranged beneath the DC electrodes.

Example 20 is an atom trap device according to Example 19, wherein the first portion of the crystalline or polycrystalline dielectric material is arranged between the structured metal layer and a metal layer arranged above the substrate.

Example 21 is an atom trap device according to Example 19 or 20, wherein the crystalline or polycrystalline dielectric material comprises a second portion at least partially arranged beneath the at least one RF electrode.

Example 22 is an atom trap device according to Example 11 and Example 21, wherein the second portion of the crystalline or polycrystalline dielectric material is arranged between the structured metal layer and the amorphous dielectric material.

Example 23 is an atom trap device according to Example 11 and any of Examples 19 to 22, wherein the crystalline or polycrystalline dielectric material comprises a third portion arranged above the amorphous dielectric material as well as between the at least one RF electrode and the DC electrodes.

Example 24 is an atom trap device according to any of the preceding Examples, wherein the substrate comprises at least one of silicon, silicon carbide, fused silica, sapphire, glass, aluminum nitride, diamond.

Example 25 is a method for manufacturing an atom trap device, the method comprising: providing a substrate; forming a dielectric material above the substrate, wherein the dielectric material is crystalline or polycrystalline; and forming a structured metal layer above the crystalline or polycrystalline dielectric material, wherein the structured metal layer is configured to generate at least one of a magnetic, electric or electromagnetic field for controlling atoms in a zone above the structured metal layer, wherein the crystalline or polycrystalline dielectric material comprises at least one planar layer extending substantially parallel to the structured metal layer, and wherein the crystalline or polycrystalline dielectric material is in contact with the structured metal layer.

The words “over”, “above”, “beneath”, or the like, with regard to a part, element or material layer formed or located or arranged “over”, “above” or “beneath” a surface may be used herein to mean that the part, element or material layer be located (e.g. placed, formed, arranged, deposited, etc.) “directly over”, “directly above” or “directly beneath”, e.g. in direct contact with, the implied surface. The words “over”, “above”, “beneath”, or the like, used with regard to a part, element or material layer formed or located or arranged “over”, “above” or “beneath” a surface may, however, either be used herein to mean that the part, element or material layer be located (e.g. placed, formed, arranged, deposited, etc.) “indirectly over”, “indirectly above” or “indirectly beneath” the implied surface, with one or more additional parts, elements or layers being arranged between the implied surface and the part, element or material layer.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The expression “and/or” should be interpreted to cover all possible conjunctive and disjunctive combinations, unless expressly noted otherwise. For example, the expression “A and/or B” should be interpreted to mean A but not B, B but not A, or both A and B. The expression “at least one of” should be interpreted in the same manner as “and/or”, unless expressly noted otherwise. For example, the expression “at least one of A and B” should be interpreted to mean A but not B, B but not A, or both A and B.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. An atom trap device, comprising:
a substrate;
a structured metal layer arranged above the substrate and configured to generate at least one of a magnetic, electric or electromagnetic field for controlling atoms in a zone above the structured metal layer;
a crystalline or polycrystalline dielectric material arranged between the substrate and the structured metal layer,
wherein the crystalline or polycrystalline dielectric material comprises at least one planar layer extending substantially parallel to the structured metal layer, and
wherein the crystalline or polycrystalline dielectric material is in contact with the structured metal layer.

2. The atom trap device of claim 1, further comprising:
a further metal layer arranged between the substrate and the crystalline or polycrystalline dielectric material, wherein the further metal layer is in contact with the substrate.

3. The atom trap device of claim 1, wherein an average grain size of the crystalline or polycrystalline dielectric material is at least 4 nm.

4. The atom trap device of claim 1, wherein the structured metal layer is configured to trap atoms in the zone above the structured electrode layer.

5. The atom trap device of claim 1, wherein the crystalline or polycrystalline dielectric material forms part of a heat bridge between the structured metal layer and the substrate.

6. The atom trap device of claim 1, wherein the crystalline or polycrystalline dielectric material is arranged beneath at least one RF electrode included in the structured metal layer.

7. The atom trap device of claim 1, wherein the crystalline or polycrystalline dielectric material is arranged beneath at least one microwave structure formed in the structured metal layer.

8. The atom trap device of claim 1, wherein the crystalline or polycrystalline dielectric material comprises at least one of aluminum nitride, silicon nitride, aluminum oxide, beryllium oxide, and beryllium nitride.

9. The atom trap device of claim 1, wherein the crystalline or polycrystalline dielectric material is in contact with the substrate.

10. The atom trap device of claim 1, further comprising:
at least one metal via extending through the substrate in a direction substantially perpendicular to the structured metal layer, wherein the at least one metal via is in contact with the crystalline or polycrystalline dielectric material.

11. The atom trap device of claim 1, further comprising:
an amorphous dielectric material arranged between the substrate and the structured metal layer, wherein the crystalline or polycrystalline dielectric material is arranged between the amorphous dielectric material and the structured metal layer.

12. The atom trap device of claim 11, wherein the amorphous dielectric material comprises silicon dioxide.

13. The atom trap device of claim 11, further comprising:
a plurality of wires embedded in the amorphous dielectric material and configured to generate a magnetic field gradient in the zone above the structured metal layer when carrying electrical currents, wherein the crystalline or polycrystalline dielectric material is in contact with at least one wire of the plurality of wires.

14. The atom trap device of claim 11, wherein the amorphous dielectric material and the crystalline or polycrystalline dielectric material form a layer stack comprising alternating layers of the amorphous dielectric material and the crystalline or polycrystalline dielectric material.

15. The atom trap device of claim 11, further comprising:
at least one metal via extending through the amorphous dielectric material in a direction substantially perpendicular to the structured metal layer, wherein the at least one metal via is in contact with the crystalline or polycrystalline dielectric material.

16. The atom trap device of claim 15, further comprising:
a metal layer arranged above the substrate and embedded in the amorphous dielectric material, wherein the at least one metal via is in contact with the metal layer.

17. The atom trap device of claim 16, wherein the metal layer comprises a ground layer, and wherein the at least one metal via provides an electrical connection between the ground layer and a ground plane of a coplanar waveguide formed in the structured metal layer.

18. The atom trap device of claim 1, wherein the structured metal layer is configured to generate a magnetic field gradient in the zone above the structured electrode layer.

19. The atom trap device of claim 1, wherein the structured metal layer comprises at least one RF electrode and a plurality of DC electrodes arranged along at least one RF electrode, and wherein the crystalline or polycrystalline dielectric material comprises a first portion arranged beneath the DC electrodes.

20. The atom trap device of claim 19, wherein the first portion of the crystalline or polycrystalline dielectric material is arranged between the structured metal layer and a metal layer arranged above the substrate.

21. The atom trap device of claim 19, wherein the crystalline or polycrystalline dielectric material comprises a second portion at least partially arranged beneath the at least one RF electrode.

22. The atom trap device of claim 21, further comprising:
an amorphous dielectric material arranged between the substrate and the structured metal layer, wherein the crystalline or polycrystalline dielectric material is arranged between the amorphous dielectric material and the structured metal layer, wherein the second portion of the crystalline or polycrystalline dielectric material is arranged between the structured metal layer and the amorphous dielectric material.

23. The atom trap device of claim 19, further comprising:
an amorphous dielectric material arranged between the substrate and the structured metal layer, wherein the crystalline or polycrystalline dielectric material is arranged between the amorphous dielectric material and the structured metal layer, wherein the crystalline or polycrystalline dielectric material comprises a third portion arranged above the amorphous dielectric material as well as between the at least one RF electrode and the DC electrodes.

24. The atom trap device of claim 1, wherein the substrate comprises at least one of silicon, silicon carbide, fused silica, sapphire, glass, aluminum nitride, and diamond.

25. A method for manufacturing an atom trap device, the method comprising:
providing a substrate;
forming a crystalline or polycrystalline dielectric material above the substrate; and
forming a structured metal layer above the crystalline or polycrystalline dielectric material and configured to generate at least one of a magnetic, electric or electromagnetic field for controlling atoms in a zone above the structured metal layer,
wherein the crystalline or polycrystalline dielectric material comprises at least one planar layer extending substantially parallel to the structured metal layer,
wherein the crystalline or polycrystalline dielectric material is in contact with the structured metal layer.
